(19) United States
(12) Patent Application Publication
(10) Pub. No.: US 2018/0315410 A1
(43) Pub. Date: Nov. 1, 2018

(54) CONTOURED INSULATOR WITH CONTROLLED AIR FLOW RESISTANCE, AND METHOD OF MAKING

(71) Applicant: Lydall, Inc., Manchester, CT (US)

(72) Inventors: Brian Matthew Jarrard, Thurmond, NC (US); Stephen Craig Brown, LaSalle (CA)

(73) Assignee: Lydall, Inc., Manchester, CT (US)

(21) Appl. No.: 15/955,135

(22) Filed: Apr. 17, 2018

Related U.S. Application Data
(60) Provisional application No. 62/491,008, filed on Apr. 27, 2017.

(51) Int. Cl. G10K 11/168

(52) U.S. Cl. CPC G10K 11/168

(57) ABSTRACT

An acoustical insulator having a composite air flow resistance is presented. The insulator may be for being positioned within a void space, and may include first and second sheets. The sheets may be joined to each other in an overlapping configuration along their respective peripheral edges, thereby defining an overlapped area between them. The sheets may include contours, such that the acoustical insulator substantially conforms to a peripheral boundary of the void space. The overlapped area may define a substantially closed air gap between the adjoined first and second sheets, the air gap having variable gap lengths along the respective sheet areas. The density of at least one of the sheets may vary with the variable gap length, so that the sheets and air gap collectively provide a composite air flow resistance through the insulator to absorb noise at a predetermined peak frequency.

### CROSS-REFERENCE TO RELATED APPLICATIONS

This application claims the benefit of U.S. Provisional Patent Application No. 62/491,008 filed Apr. 27, 2017, which is incorporated herein by reference in its entirety.

### FIELD

An acoustical insulator is generally described. More specifically, acoustical insulators for being positioned within a void space having a peripheral boundary, and a method of making the acoustical insulators, are described.

### BACKGROUND

Thermal and/or acoustical shields, to which the presently described embodiments are an improvement, have long been known in the art. Such shields are used in a wide variety of applications, among which are shielding in spacecraft, aircraft, trains, automobiles, home appliances, electronic components, industrial engines, boiler plants and the like. These shields are commonly referred to as heat shields, acoustical panels, thermal barriers, vibrational barriers, insulating barriers, and the like. The acoustical insulating value of a shield may vary in any one configuration, where, for instance, more or less of frequency ranges of sound needs to be absorbed.

Known acoustical shields purposed for acoustical shielding and/or acoustic damping include those made of multiple aluminum foil layers that are provided with an embossed surface. Typically, the embossments are provided in an alternating relationship in each layer to create a gap between adjacent aluminum layers. A disadvantage with these acoustical shields is that the embossments may create undesirable noises, such as rattling, because they are in direct contact with their opposing aluminum foil layers. Further, the gaps can allow fluids to travel between the layers, which can fail to reduce sound from traveling through the shield. Even further, such acoustical shields may include fibers and/or honeycomb materials positioned between one or more of adjacent aluminum foil layers in a sandwich-type structure in order to reduce sound from traveling through the shield. A disadvantage of these shields is that they result in shields having a relatively large thickness and/or may be heavy, which may be difficult to install in areas where a lightweight acoustical shield is required.

Other types of presently used acoustical shields include sheets of fibrous materials placed within a desired area. Because the areas to be shielded may include one or more contours, such shields are often contoured to fit in those spaces. When such shields include two or more layers, a gap is usually provided between these layers. In some instances, another fibrous material may be placed in between these layers. A disadvantage with these assemblies, is that they are often relatively thick/dense and heavy, and may not fit in tight spaces, may be too bulky and difficult to install and/or may fail to absorb sound at a desired frequency range. Additionally, the use of numerous layers may results in an acoustical shield that is not only heavy, but also costly.

In view of the disadvantages associated with currently available methods and devices for acoustical sound absorption, there is a need for a device and method that absorbs sound, such as noise, at a predetermined frequency.

### BRIEF DESCRIPTION

According to an aspect, the present embodiments may be associated with an acoustical insulator having a composite air flow resistance. The acoustical insulator may be for being positioned within a void space, the void space having a peripheral boundary. According to an aspect, the acoustical insulator includes a first sheet and a second sheet, the first sheet and the second sheet each including a fibrous, air permeable material having a density, wherein the first sheet and the second sheet each include a respective sheet area bounded by a respective peripheral edge. In an embodiment, the first sheet and the second sheet are joined to one another in an at least partially overlapping configuration along at least a portion of peripheral edge of at least one of the first sheet and the second sheet, thereby defining an overlapped area between the first sheet and the second sheet. According to an aspect, at least one of the first sheet and the second sheet includes contours along the respective sheet area so that the acoustical insulator substantially conforms to the peripheral boundary of the void space. The overlapped area may define a substantially closed air gap between the adjoined first sheet and second sheet, with the air gap having a variable gap length along the respective sheet areas. According to an aspect, the density of at least one of the first sheet and the second sheet varies with the variable gap length, so that the first sheet, air gap, and second sheet are collectively operative for providing a desired air flow resistance (i.e. composite air flow resistance) through the acoustical insulator to absorb noise at a predetermined peak frequency, or frequency band.

The present embodiments may further be associated with an acoustical insulator for being positioned within a void space having a peripheral boundary, where the acoustical insulator includes a first sheet shaped to conform to a first portion of the peripheral boundary of the void space, and a second sheet shaped to conform to a second portion of the peripheral boundary of the void space. According to an aspect, the first sheet and the second sheet are joined to one another so that the adjoined first sheet and second sheet substantially extend along the peripheral boundary of the void space, and so that an air gap is defined between the first sheet and the second sheet. In an embodiment, the air gap includes a plurality of gap lengths measured between the first sheet and the second sheet. According to an aspect, the first sheet and the second sheet each include a fibrous material having a plurality of fiber densities, wherein for each gap length of the plurality of gap lengths, the density of the adjacent fibrous material of at least one of the first sheet and the second sheet is selected so that the acoustical insulator has a composite air flow resistance operative for providing acoustical abatement at a predetermined peak frequency.

More specifically, the present embodiments relate to a method of making an acoustical insulator for absorbing noise at a predetermined peak frequency, or frequency range, where the acoustical insulator is for being positioned in a void space bounded by an outer periphery. The method may include shaping a first sheet to conform to a first portion of the outer periphery of the void space, and shaping a second sheet to conform to a second portion of the outer periphery of the void space, where the first sheet and the second sheet each include an air permeable, fibrous material having a density and a thickness. According to an aspect, the method further includes joining the shaped first sheet and the shaped second sheet to one another, so that a substantially closed air gap is defined between the first sheet and the second sheet, and so that the first sheet and second sheet joined to one another substantially fill the void space, where the first sheet, second sheet, and air gap define a plurality of regions each having a gap length defined between the first sheet and the second sheet. The method may include reducing the thickness of at least one of the first sheet and the second sheet in at least one region of the plurality of regions, wherein reducing the thickness increases the density of the at least one of the first sheet and the second sheet in the respective region so that a composite air flow resistance through the respective region is operative for reducing noise at the predetermined peak frequency or frequency range.

### BRIEF DESCRIPTION OF THE FIGURES

A more particular description will be rendered by reference to specific embodiments thereof that are illustrated in the appended drawings. Understanding that these drawings depict only typical embodiments thereof and are therefore to be considered to be limiting of its scope, exemplary embodiments will be described and explained with additional specificity and detail through the use of the accompanying drawings in which:

FIG. 1 is a cross-sectional, view of an acoustical insulator, according to an embodiment;

FIG. 2 is a cross-sectional view of an acoustical insulator, according to an embodiment;

FIG. 3 is a cross-sectional view of a section of the acoustical insulator of FIG. 2;

FIG. 4 is a perspective view of an acoustical insulator installed in a void space, according to an embodiment;

FIG. 5 is a flow chart illustrating a method of making an acoustical insulator, according to an embodiment;

FIG. 6 is a graphical illustration of normal incidence absorption of acoustical insulators assembled according to FIGS. 1-2 having a 10 mm air gap; and

FIG. 7 is a graphical illustration of normal incidence absorption of acoustical insulators assembled according to FIGS. 1-2 having a 20 mm air gap.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

### DETAILED DESCRIPTION

Embodiments of the present disclosure relate generally to acoustical insulators for absorbing noise. The acoustical insulators may be positioned within void spaces at specific locations in, for example, automobiles, and may facilitate the absorption of noise at a predetermined peak frequency or frequency range for its respective specific location. Additionally, the acoustical insulators may include a first sheet and a second sheet, each sheet having tunable/adjustable composite air flow resistance and adjustable contours that can create and/or modify a gap between the first and second sheets, to shift the absorption peak for the needs of the application. Thus, the present application provides a customizable acoustical insulator that may be modified based on the needs of the application for which it is to be used. This may reduce the number of sheets and/or layers of sheets used in the acoustical insulator, which may in turn help provide a lightweight acoustical shield. Additionally, the contours and gaps of the customizable acoustical insulator may help facilitate the acoustical insulator's arrangement in void spaces of different sizes, shapes and/or frequency ranges.

For purposes of illustrating features of the embodiments, a simple example will now be introduced and referenced throughout the disclosure. Those skilled in the art will recognize that this example is illustrative and not limiting and is provided purely for explanatory purposes.

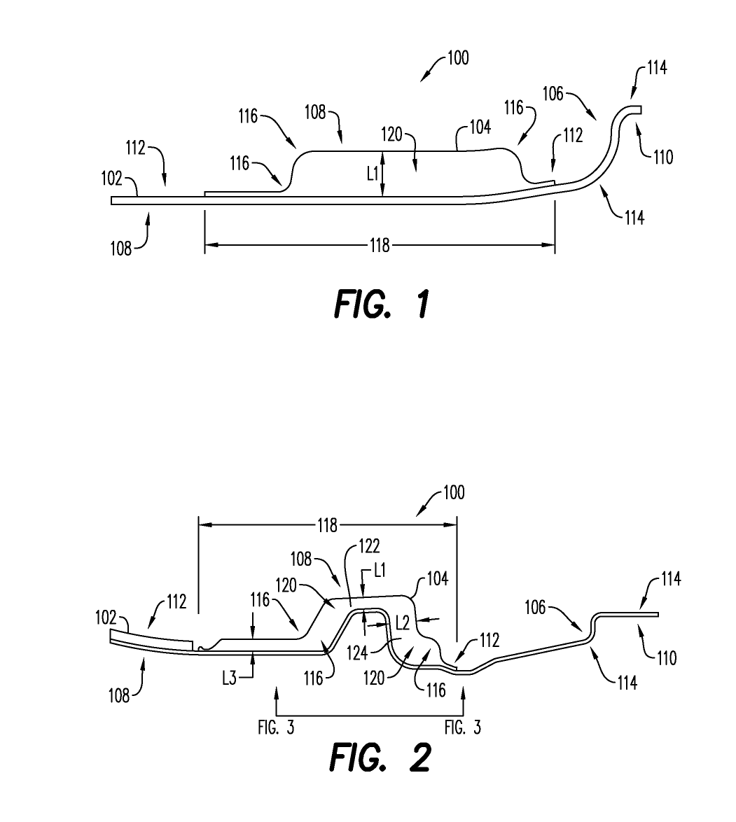

Turning now to FIGS. 1-4, an acoustical insulator 100 is illustrated. The acoustical insulator 100 may be configured for being positioned within a void space that includes a peripheral boundary. For example, the void space may be defined between a plurality of parts/vehicle parts in a vehicle/automobile. In such a case, the peripheral boundary may be defined at least in part by the outermost surfaces of the vehicle parts between which the acoustical insulator 100 is to be positioned. According to an aspect, the acoustical insulator 100 occupies the space available between the vehicle parts of the vehicle in which it is arranged. If the space is large in size or includes a complex/three-dimensional shape, the acoustical insulator 100 may be customized to fit within that space. For instance, the plurality of parts may include a vehicle door having an inner door panel, and an outer door panel at least partially spaced apart from the inner door panel. The acoustical insulator 100 may be arranged between the inner door panel and the outer door panel to provide acoustical insulation.

According to an embodiment, the acoustical insulator 100 includes a first sheet 102 and a second sheet 104. As will be explained in further detail hereinbelow, each sheet 102, 104 is at least partially spaced apart from the other adjacent sheet. Each sheet 102, 104 may be a generally flexible and resilient sound absorbing material. According to an aspect, the sheets 102, 104 are supplied in a rolled form to thereafter be cut into a desired shape and/or size. The sheets 102, 104 may include a pre-cut, flat/planar sheet/ply/layer of stock material. According to an aspect, the sheets 102, 104 are fabricated/formed/shaped by compression in order to achieved a desired contour to assist with the dissipation of an undesired acoustic/sound. In an embodiment, the sheets 102, 104 are molded/shaped for installment between, for instance, the plurality of parts in a vehicle. Each sheet 102, 104 may include a thermoformable material. The thermoformable material may be provided as a two-dimensional/flat sheet of material that, when placed in a heated thermoforming/molding tool having a mold shape, adopts a three-dimensional shape of the thermoforming tool. According to an aspect, the acoustical insulator 100 has an activation temperature that is lower than a respective temperature of the thermoforming tool. Thus, when the flat sheet of thermoformable material is positioned in the thermoforming tool and heat activated whilst therein, the thermoformable material results in a three-dimensionally shaped/contoured acoustical insulator 100.

As illustrated in FIGS. 1-2 and according to an aspect, the first and second sheets 102, 104 each have a respective sheet area 106, 108. In an embodiment, the sheet area 106 of the first sheet 102 is bound by a peripheral edge 110. The sheet area 108 of the second sheet 104 may similarly be bound by a respective peripheral edge 112. To be sure, in at least one configuration, both of the respective sheet areas 106, 108 are bounded by their respective peripheral edges 110, 112. According to an aspect, at least one of the first sheet 102 and the second sheet 104 are joined together so that one of the sheets 102, 104 at least partially overlaps the other respective sheet. As illustrated in FIG. 1, the peripheral edge 112 of the second sheet 104 may join/abut a portion of the sheet area 106 of the first sheet 102, so that the peripheral edge 110 of the first sheet 102 extends beyond both the sheet area 108 and peripheral edge 112 of the first sheet 102. According to an aspect, the peripheral edge 110 of the first sheet 102 is joined to a portion of the sheet area 108 of the second sheet 104, so that the peripheral edge 112 of the second sheet 104 extends beyond both the sheet area 106 and peripheral edge 110 of the second sheet 104. As illustrated in FIG. 2, at least one portion of both peripheral edges 112, 114 may be joined together, while another portion of at least one of the peripheral edges 112, 114 may overlap the other. The aforementioned overlapping configurations may be formed by virtue of one the first sheet 102 and the second sheet 104 including a sheet area/length that is greater than the respective sheet area/length of the adjoining sheet. In an embodiment, the respective lengths of each of the first and second sheets 102, 104 may be the same, and the overlapping configuration may be formed by virtue of a two-dimensional shape/orientation or a three-dimensional shape/orientation of at least one of the first and second sheets 102, 104.

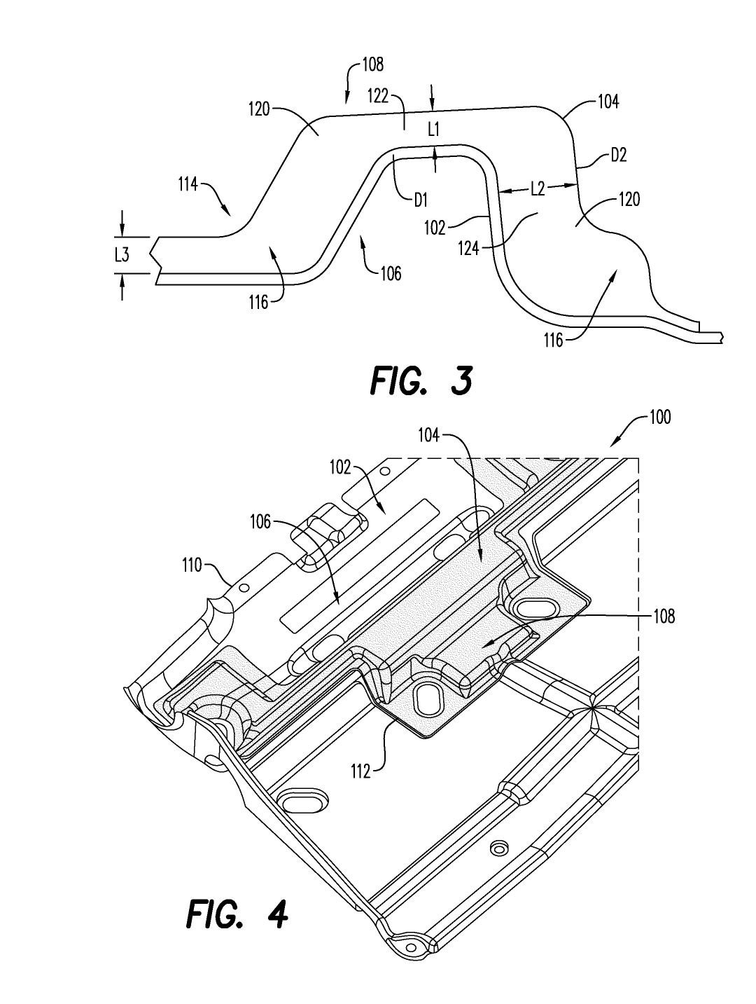

According to an aspect, the overlapping configuration helps to define an overlapped area 118 between the first sheet 102 and the second sheet 104. As illustrated in FIGS. 2-3, the overlapped area 118 defines a substantially closed air gap 120 between the adjoined first and second sheets 102, 104. When measured along various points of the overlapped area 118 between the first sheet 102 and second sheet 104, the air gap 120 may include a variable gap length/a plurality of gap lengths L1, L2, L3 along the respective sheet areas 106, 108. Each of the gap lengths L1, L2, L3 may be sized according to the special arrangement available for the acoustical insulator 100. According to an aspect, the gap lengths L1, L2, L3 are modified/varied based on the desired absorption frequency range of the acoustical insulator 100. The gap lengths L1, L2, L3 may be varied so that absorb a specific noise level/frequency. For instance, a gap length L1 of about 10 mm may absorb noise levels of about 2,100 Hz in some areas, and another gap length L2 of about 20 mm may absorb noise levels of about 4,000 Hz in other areas of the acoustical insulator 100. According to an aspect, the variable gap lengths L1, L2, L3 varies from about 2 mm to about 100 mm. The variable gap lengths may be from about 2 mm to about 50 mm. As will be explained in further detail hereinbelow, the gap lengths L1, L2, L3, coupled with the respective air flow resistance of each of the first sheet 102 and the second sheet 104, may be modified based on the desired noise absorption and/or the needs of the application in which the acoustical insulator 100 is being utilized.

At least one of the first sheet 102 and the second sheet 104 may include contours 114, 116 along their respective sheet areas 106, 108. Each contour 114, 116 may include one or more peaks and/or one or more valleys extending along their respective sheet areas 106, 108. The contours of each sheet may be the same or may differ from one another. As seen for instance in FIG. 2, the contours 114 of the first sheet 102 may be substantially the same as at least a portion of the contours 116 of the second sheet 104. As illustrated in FIG. 1, the contours 114 of the first sheet 102 extend along a portion of its peripheral edge 110, while the contours 116 of the second sheet 104 extend between portions of its peripheral edge 112. According to an aspect and as illustrated in FIG. 2, the contours 114 of the first sheet 102 are different from the contours 116 of the second sheet 104.

At least one of the contours 114 of the first sheet 102 and the contours 116 of the second sheet 104 may be shaped according to the space within which the insulator 100 is arranged. In an embodiment, the first sheet 102 and the second sheet 104 are contoured such that they individually substantially conform to the peripheral boundary of the void space within which the acoustical insulator 100 is positioned. At least one of the sheets 102, 104 may be contoured to conform to the shape of the vehicle part, so that the sheet may be positioned proximate or directly adjacent to the vehicle part, while the other sheet may be contoured to increase or decrease the gap lengths L1, L2, L3 between the first sheet 102 and the second sheet 104. By doing so, the contours 114, 116 not only help optimize the air gap between the first and second sheets 106, 108, relative to the space within which the acoustical insulator 100 is being arranged/installed, but also helps to maximize sound/noise absorption. For example, when the insulator 100 is to be placed in a wheel well of a vehicle, the first and second sheets 102, 104 are contoured so that one sheet corresponds to the underside of the vehicle at the position closest to the body of the vehicle and the other sheet generally correspond to the curved shape of the wheel. In any event, when the source of the noise/undesirable sound is a vehicle part, at least one of the sheets 102, 104 may shaped to conform to the shape of that vehicle part and the other sheet will include contours that are shaped to optimized the gap between the two sheets 102, 104.

In an embodiment, at least one of the first sheet 102 and the second sheet 104 may be formed from a moldable material, such as an open cell foam, a closed cell foam, a fibrous material, or any combination thereof. According to an aspect, the molded material is sufficiently stiff so that the air gap 120 is maintained between the first sheet 102 and the second sheet 104. In an embodiment where at least one of the first sheet 102 and the second sheet 104 is a fibrous material, the fibrous material may be formed from needled polyester fibers. One or both sides of at least one of the first sheet 102 and the second sheet 104 may be needle-punched. According to an aspect, the fibrous materials are hydro-entangled.

Each of the first and second sheets 102, 104 may be air permeable. The sheets 102, 104 may be air permeable by virtue of having small channels/gaps/pores that extend through a depth of each sheet 102, 104, thus allowing at least some air to flow therethrough. As the air flows through the channels, noise may be dissipated or substantially reduced by friction. According to an aspect, the thickness of the sheets 102, 104 may be adjusted to either increase sound absorption or reduce sound absorption. For instance, as the thickness of the sheets 102, 104 increases, air permeability may be reduced and flow resistance increased, which may help to enhance the sound absorption of the sheet. Alternatively, when reduction of the thickness of at least one of the first and second sheets 102, 104 may increase air permeability and decrease air flow resistance, thus reducing the sound absorption of the sheets 102, 104.

According to an aspect, the first and second sheets 102, 104 each have a respective density. In an embodiment, the first and second sheets 102, 104 each have the same density. According to an aspect, the first sheet 102 has a density that is different from the respective density of the second sheet 104. It is envisioned that the density of the sheets 102, 104 will be selected based on the frequency of the sound to be absorbed. For instance, the density of at least one of the sheets 102, 104 may be reduced to absorb sounds of low frequencies, such as frequencies of about 500 Hz. According to an aspect, the density of at least one of the sheets 102, 104 may be increased to help absorb sounds having frequencies of about 2,000 Hz.

The densities of the first sheet 102 and the second sheet 104 may be determined by measuring the respective basis weights of the sheets 102, 104. The basis weights, and therefore the densities, of the first and second sheets 102, 104 may be adjusted depending on the needs of the application, such as, for example, the size/area of the void space within which the insulator 100 is to be arranged. In an embodiment, the first and second sheets 102, 104 each have basis weights that are substantially the same. In an embodiment, the first sheet 102 and the second sheet 104 each include different basis weights. For instance, in an embodiment, the first sheet 102 has a basis weight of from about 300 gsm to about 2,000 gsm, and the second sheet 104 has a basis weight of from about 200 gsm to about 1,200 gsm. In an embodiment, the first sheet has a basis weight of from about 900 gsm to about 2,000 gsm, and the second sheet 104 has a basis weight of from about 500 gsm to about 1,200 gsm. In an embodiment, at least one of the first and second sheets 102, 104 includes a basis weight that is less than about 900 gsm. According to an aspect, the basis weight of at least one of the first sheet 102 and the second sheet 104 is about 500 gsm.

In an embodiment, the density of at least one of the first sheet 102 and the second sheet 104 may also vary with the variable gap length, so that the first sheet 102, the air gap 120, and the second sheet 104 are collectively operative for providing a desired composite air flow resistance through the acoustical insulator 100. The composite air flow resistance may help to absorb and/or abate noise at a predetermined peak frequency/frequency band. For example, an acoustical insulator 100 for absorbing a frequency of about 1,000 Hz when positioned in a void space may include first and second sheets 102, 104 each having a density of about 0.344 g/cc and an air flow resistance of about 1200 MKS Rayls, and the air gap 120 between the first sheet 102 and the second sheet 104 may be sized to about 10 mm and contoured to provide for absorption of the 1,000 Hz. In other words, the composite air flow resistance may be tuned relative to the air gap available, which may be relative to the shape of, for instance, the vehicle parts between which the acoustical insulator 100 is to be positioned, to maximize noise absorption within the desired frequency range.

In an embodiment, the first sheet 102 and the second sheet 104 each include a respective air flow resistance. The composite air flow resistance of the acoustical insulator 100 may include the respective air flow resistance of the first sheet 102 and the respective air flow resistance of the second sheet 104. In an embodiment, the respective air flow resistance is from about 400 MKS rayls to about 2000 MKS rayls, for both the first sheet 102 and the second sheet 104, individually. In an embodiment, the respective air flow resistance is from about 600 MKS rayls to about 1500 MKS rayls, for both the first sheet 102, and the second sheet 104, individually. According to an aspect, the air flow resistance of the first sheet 102 and the second sheet 104 is controlled relative to the air gap 120 between the first and second sheets 102, 104. The air flow resistances may be adjusted by changing the thickness of at least one of the first sheet 102 and the second sheet 104. For instance, some applications may include a targeted frequency range that is problematic or needs to be absorbed, however, there is insufficient/limited available space for installing the insulator 100. This issue may be addressed by tuning/adjusting the respective air flow resistances and the contours 114, 116 of at least one of the first sheet 102 and the second sheet 104 to change/vary the gap between the first sheet 102 and the second sheet 104, thus shifting the absorption peak to match the needs of the application and absorbing the desired frequency range. In other words, a specific frequency range may be absorbed by selecting sheets 102, 104 having specific air flow resistances, and varying the contours 114, 116 and/or adjusting the gap between each sheet 102, 104.

According to an aspect, the acoustical insulator 100 may be positioned adjacent a vehicle part. According to an aspect, the void space within which the acoustical insulator 100 is arranged may be positioned between a first vehicle part and a second vehicle part. In an embodiment, the first sheet 102 is contoured to substantially conform to an outer surface of the first vehicle part, while the second sheet 104 is contoured to substantially conform to an outer surface of the second vehicle part. This helps ensure that that the acoustical insulator 100 adopts/conforms to the outer surfaces of the parts between which it is to be positioned.

In an embodiment, the first portion of the peripheral boundary and the second portion of the peripheral boundary substantially include the entire peripheral boundary of the void space, so that the adjoined first sheet 102 and second sheet 104 substantially fill the void space. To be sure, the overlapped area 118 between the first and second sheets 102, 104 may include/fill substantially all of the void space within which the acoustical insulator 100 is positioned. According to an aspect, the overlapped areas/regions 118 may include about 10% to about 90% of a total area of the void space. In an embodiment, the overlapped area/regions 118 includes about 20% to about 50% of the total area of the void space. The flexibility of the overlapped area 118 may be particularly beneficial in applications that may only have enough space to accommodate the presence of one of the first sheet 102 and the second sheet 104 of the acoustical insulator 100.

In an embodiment, the first sheet 102 and the second sheet 104 of the acoustical insulator 100 are joined to one another in an opposed, facing relationship, the first sheet 102 and the second sheet 104 each including a fibrous, air permeable material. As described in further detail hereinabove, at least one of the first sheet 102 and the second sheet 104 may be contoured. When contoured, the first sheet 102 and second sheet 104 may substantially extend along the peripheral boundary of the void space. According to an aspect and as illustrated in FIG. 3, where the first sheet 102 and the second sheet 104 overlap each other, they may be spaced from each another at the overlapped areas, thereby forming/defining the air gap 120 between the first sheet 102 and the second sheet 104. The air gap 120 may include multiple gap lengths L1, L2, L3. For example, the air gap 120 may include at least a first gap length L1 in a first area 122 and a second gap length L2 in a second area 124 between the sheets 102, 104. In an embodiment, the first gap length L1 includes a first distance that is less than a second distance of the second gap length L2. According to an aspect and as illustrated in FIG. 3, in the first area 122, at least one of the first sheet 102 and the second sheet 104 includes a density D1 that is greater than the density D2 of the respective sheet 102, 104 in the second area 124. In this configuration, the first area 122 includes the first gap length L1 and the first density D1, and the second area 124 includes the second gap length L2 and the second density D2, each being operative for providing an air flow resistance through the acoustical insulator 100 so that predetermined peak frequency/range of the noise is absorbed/abated. This flexibility in the selection of the contours of each sheet 102, 104, and the gap lengths L1, L2 between them may be particularly useful in, for instance, the wheel well, door, roof, and engine compartment regions of an automobile, which may each include various contours and distinct frequency ranges to be absorbed.

As seen for instance in FIG. 4, the acoustical insulator 100 may be positioned within a void space, for example, in an automobile engine and/or adjacent an engine cover. As discussed above, the void space may include a peripheral boundary defined by the outermost surfaces of the engine compartment of the automobile. The first sheet 102 of the acoustical insulator 100 may be contoured so that when placed adjacent the engine, the acoustical insulator 100 generally conforms to the shape of the engine. The second sheet 104 may be contoured to include the air gap 120 that, along with the air flow resistances of each of the first and second sheets 102, 104, aid to absorb the noise frequencies emanating from the engine parts. According to an aspect, the acoustical insulator 100 includes the first sheet 102 and the second sheet 104. The first sheet 102 may be shaped to conform to a first portion of the peripheral boundary of the void space, and the second sheet 104 may be shaped to conform to a second portion of the peripheral boundary of the void space. The various details provided about the acoustical insulator 100 and the first and second sheets 102, 104 in connection with FIGS. 1-3 are likewise applicable to this embodiment (such details are not repeated here for purposes of convenience and not limitation).

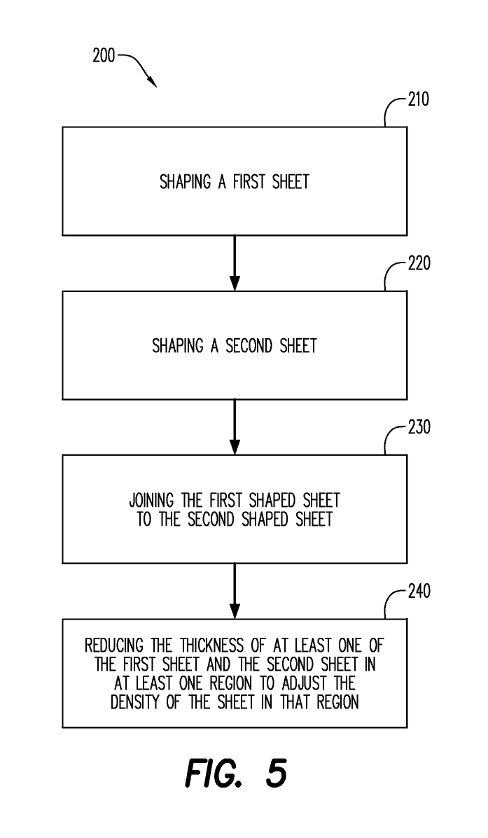

Embodiments of the disclosure relate to a method 200 of making an acoustical insulator for being positioned in a void space bounded by an outer periphery. The acoustical insulator may absorb/abate noise at a predetermined peak frequency/frequency range. According to an aspect and as illustrated in FIG. 5, the method 200 may include shaping 210 a first sheet 102 to conform to a first portion of the outer periphery of the void space, and shaping 220 a second sheet 104 to conform to a second portion of the outer periphery of the void space, thus ensuring that the acoustical insulator 100 will confirm to the peripheral boundary of the void space. In an embodiment, the first sheet and the second sheet each include an air permeable, fibrous material having a density and a thickness. According to an aspect, the method includes joining 230 the shaped first sheet and the shaped second sheet to one another, so that a substantially closed air gap 120 is defined between the first sheet 102 and the second sheet 104, and so that the first sheet and second sheet joined to one another substantially fill the void space. In this configuration, the first sheet 102, second sheet 104, and air gap 120 may define a plurality of regions. The plurality of regions may each include a gap length that is defined between the first sheet and the second sheet. The method may include reducing 240 the thickness of at least one of the first sheet 102 and the second sheet 104 in at least one region of the plurality of regions. According to an aspect, reducing the thickness may increase the density of the at least one of the first sheet 102 and the second sheet 104 in the respective region, so that a composite air flow resistance through the respective region is operative for reducing noise at the predetermined peak frequency/frequency range.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein. For instance, while two sheets, namely the first sheet 102 and the second sheet 104, are referred to herein, it is to be understood that 3, 4, 5, or more sheets may be used, depending on the needs of the particular application. The sheets are in a layered relationship with each other, such that each sheet is either overlapped by an adjacent sheet, or overlaps the adjacent sheet. When the acoustical insulator 100 is to be positioned in a particularly large void space, the use of more than two sheets may further aid with absorbing the noise at the predetermined frequency. According to an aspect, the acoustical insulator 100 includes about 7 sheets.

The present invention may be understood further in view of the following examples, which are not intended to be limiting in any manner. All of the information provided represents approximate values, unless specified otherwise.

### EXAMPLES

Various acoustical assemblies were generally configured as shown in FIGS. 1-2, with sheets being arranged with air gaps between them as set forth in Tables 1a and 1b. Each sheet included a density of 240 gsm. The Samples were tested according to ASTM E1050. Per ASTM E1050, the Samples were mounted to a sample holder and placed in a test chamber of an acoustic impedance tube. A graduated plunger was attached to the sample holder, and was also positioned within the test chamber. The graduated plunger was adjusted to create and control the air gaps between the sample sheets, per ASTM E1050. For each Sample, the results of five (5) individual samples were averaged, per ASTM E1050. The reported values are absorption coefficient (alpha) vs. frequency (Hz), which can be plotted graphically for easy comparison of the various sample and test conditions.

TABLE 1a

| | Air Gap (millimeters | Airflow Resistivity |
|---|---|---|
| Sample | (mm)) | (rayls/meter) |
| 1-1 | 10 | 67.7 |
| 1-2 | 10 | 372.0 |
| 1-3 | 10 | 58.0 |
| 1-4 | 10 | 239.3 |
| 1-5 | 10 | 609.0 |

TABLE 1b

| | Air Gap (millimeters | Airflow Resistivity |
|---|---|---|
| Sample | (mm)) | (rayls/meter) |
| 2-1 | 20 | 203.0 |
| 2-3 | 20 | 493.0 |
| 2-4 | 20 | 125.7 |
| 2-5 | 20 | 415.7 |

The acoustical assemblies made according to Tables 1a and 1b achieved air flow resistances/resistivity of about 58.0 rayls/meter to about 493.0 rayls/meter. The acoustical assemblies having an air gap of 10 mm between the first sheet 102 and the second sheet 104 demonstrated composite air flow resistances of about 58.0 rayls/meter to about 609.0 rayls/meter, while acoustical assemblies having an air gap of 20 mm between the first sheet 102 and the second sheet 104 demonstrated composite air flow resistances of about 125.7 rayls/meter to about 493.0 rayls/meter.

TABLE 2a

| | | | Weight | |
|---|---|---|---|---|
| | | Air flow | (gram per | |
| | Air Gap | Resistivity | square meter | Thickness |
| Sample | (millimeters) | (rayls/meter) | (gsm) | (millimeters (mm)) |
| 3-1 | 10 | 406 | 812 | 2.52 |
| 3-2 | 10 | 116 | 468 | 2.46 |
| 3-3 | 10 | 87 | 239 | 1.08 |
| 3-4 | 10 | 464 | 513 | 1.06 |

TABLE 2b

| | | | Weight | |
|---|---|---|---|---|
| | Air Gap | Air flow | (gram per | |
| | (millimeters | Resistivity | square meter | Thickness |
| Sample | (mm)) | (rayls/meter) | (gsm)) | (millimeters (mm)) |
| 4-1 | 20 | 841 | 730 | 1.52 |
| 4-2 | 20 | 464 | 513 | 1.06 |
| 4-3 | 20 | 348 | 537 | 1.48 |
| 4-4 | 20 | 841 | 730 | 1.52 |

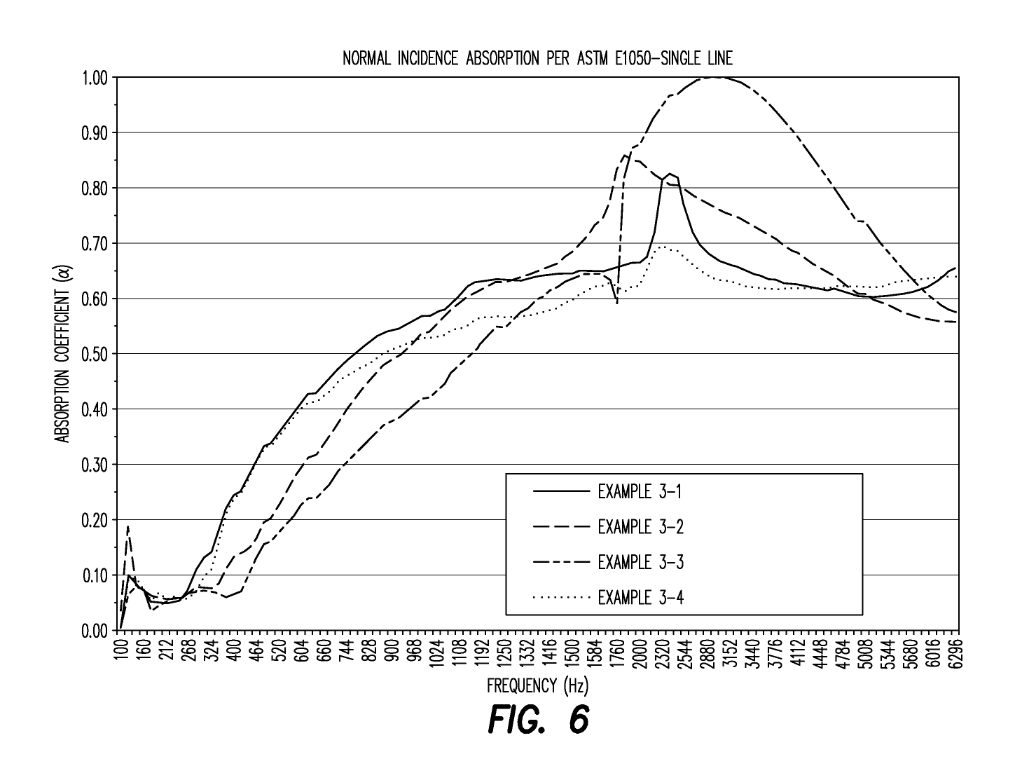

The acoustical assemblies made according to Tables 2a and 2b achieved composite air flow resistances/resistivity of about 87.0 rayls/meter to about 841.0 rayls/meter. The acoustical assemblies of Table 2 a included an air gap of 10 mm between the first sheet 102 and the second sheet 104, and demonstrated composite air flow resistances of about 87.0 rayls/meter to about 464.0 rayls/meter. The normal incidence absorption of Examples 3-1, 3-2, 3-3, and 3-4 are demonstrated in FIG. 6. Example 3-1 demonstrated a normal incidence absorption between about 2,300 Hz and about 2,500 Hz with an absorption coefficient of about 0.8α. Example 3-2 demonstrated a normal incidence absorption between about 1,700 Hz and about 2,000 Hz with an absorption coefficient of about 0.85α. Example 3-3 demonstrated a normal incidence absorption between about 2,100 Hz and about 4,100 Hz with an absorption coefficient of about 1.0α. Example 3-4 demonstrated a normal incidence absorption between about 2,300 Hz and about 2,500 Hz with an absorption coefficient of about 0.70α.

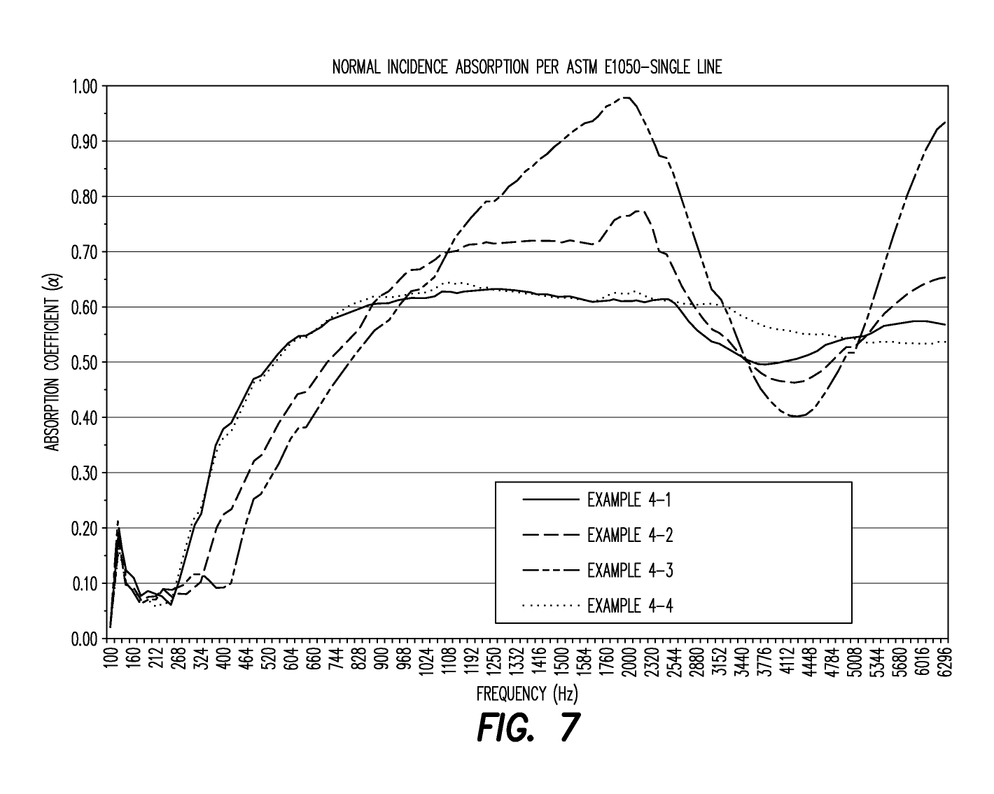

The acoustical assemblies made according to Table 2b included an air gap of 20 mm between the first sheet 102 and the second sheet 104, and demonstrated composite air flow resistances of about 125.7 rayls/meter to about 493.0 rayls/meter. The normal incidence absorption of Examples 4-1, 4-2, 4-3, and 4-4 are demonstrated in FIG. 7. Example 4-1 demonstrated a normal incidence absorption between about 1,000 Hz and about 1,300 Hz with an absorption coefficient of about 0.65α. Example 4-2 demonstrated a normal incidence absorption between about 1,700 Hz and about 2,300 Hz with an absorption coefficient of about 0.775α. Example 4-3 demonstrated a normal incidence absorption between about 2,000 Hz and about 2,300 Hz with an absorption coefficient of about 0.975α. Example 4-4 demonstrated a normal incidence absorption between about 1,100 Hz and about 2,300 Hz with an absorption coefficient of about 0.65α.

While the apparatus and method have been described with reference to specific embodiments, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the insulator and method, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. An acoustical insulator having a composite air flow resistance, and for being positioned within a void space having a peripheral boundary, the acoustical insulator comprising:
a first sheet and a second sheet, the first sheet and the second sheet each comprising a fibrous, air permeable material having a density, wherein the first sheet and the second sheet each comprise a respective sheet area bounded by a respective peripheral edge, wherein
the first sheet and the second sheet are joined to one another in at least a partially overlapping configuration along at least a portion of the peripheral edge of at least one of the first sheet and the second sheet, thereby defining an overlapped area between the first sheet and the second sheet,
at least one of the first sheet and the second sheet includes contours along the respective sheet area so that the acoustical insulator substantially conforms to the peripheral boundary of the void space,
the overlapped area defines a substantially closed air gap between the adjoined first sheet and second sheet, the air gap having a variable gap length along the respective sheet areas, and
the density of at least one of the first sheet and the second sheet varies with the variable gap length, so that the first sheet, air gap, and second sheet are collectively operative for providing the composite air flow resistance through the acoustical insulator to absorb noise at a predetermined peak frequency.

2. The acoustical insulator of claim 1, wherein the first sheet and the second sheet each include contours, and the contours of the first sheet differ from the contours of the second sheet.

3. The acoustical insulator of claim 1, wherein the first sheet and the second sheet each comprise a molded material comprising one ore more of an open cell foam, a closed cell foam, and a fibrous material.

4. The acoustical insulator of claim 3, wherein the molded material is sufficiently stiff so that the air gap is maintained between the first sheet and the second sheet.

5. The acoustical insulator of claim 3, wherein the fibrous material comprises needled polyester fibers.

6. The acoustical insulator of claim 1, wherein the first sheet has a basis weight of from about 300 gsm to about 2000 gsm, and the second sheet has a basis weight of from about 200 gsm to about 1200 gsm.

7. The acoustical insulator of claim 1, wherein the desired air flow resistance of at least one of the first sheet and the second sheet is from about 400 MKS rayls to about 2000 MKS rayls.

8. The acoustical insulator of claim 1, wherein the variable gap length varies from about 2 mm to about 100 mm.

9. The acoustical insulator of claim 1, wherein the first sheet and the second sheet each include a respective air flow resistance, and the desired air flow resistance of the acoustical insulator comprises the respective air flow resistance of the first sheet and the respective air flow resistance of the second sheet.

10. The acoustical insulator of claim 1, wherein the void space is positioned between a first vehicle part and a second vehicle part, wherein the first sheet is contoured to substantially conform to an outer surface of the first vehicle part and the second sheet is contoured to substantially conform to an outer surface of the second vehicle part.

11. An acoustical insulator having a composite air flow resistance, and for being positioned within a void space having a peripheral boundary, the acoustical insulator comprising:
a first sheet shaped to conform to a first portion of the peripheral boundary of the void space; and
a second sheet shaped to conform to a second portion of the peripheral boundary of the void space, wherein
the first sheet and the second sheet are joined to one another so that the acoustical substantially extends along the peripheral boundary of the void space, and so that an air gap is defined between the first sheet and the second sheet, wherein the air gap includes a plurality of gap lengths measured between the first sheet and the second sheet, and
the first sheet and the second sheet each comprise a fibrous material having a plurality of fiber densities, wherein for each gap length of the plurality of gap lengths, the density of the adjacent fibrous material of at least one of the first sheet and the second sheet is selected so that the acoustical insulator has the composite air flow resistance operative for providing acoustical attenuation at a predetermined peak frequency.

12. The acoustical insulator of claim 11, wherein the first portion of the peripheral boundary and the second portion of the peripheral boundary substantially comprise the entire peripheral boundary of the void space, so that the acoustical insulator substantially fills the void space.

13. The acoustical insulator of claim 11, wherein at least one of the first sheet and the second sheet includes contours to conform to the respective peripheral boundary of the void.

14. The acoustical insulator of claim 11, wherein the first sheet and the second sheet each include contours, and the contours of the first sheet differ from the contours of the second sheet.

15. The acoustical insulator of claim 11, wherein the first sheet and the second sheet each comprise a molded material comprising one or more of an open cell foam, a closed cell foam, and a fibrous material.

16. The acoustical insulator of claim 13, wherein the first sheet and the second sheet are sufficiently stiff so that the air gap is maintained between the first sheet and the second sheet.

17. The acoustical insulator of claim 11, wherein the first sheet has a basis weight of from about 300 gsm to about 2000 gsm, and the second sheet has a basis weight of from about 200 gsm to about 1200 gsm.

18. The acoustical insulator of claim 11, wherein the air flow resistance of at least one of the first sheet and the second sheet is from about 400 MKS rayls to about 2000 MKS rayls.

19. The acoustical insulator of claim 11, wherein the plurality of gap lengths are independently from about 2 mm to about 100 mm.

20. An acoustical insulator having a composite air flow resistance, and for being positioned within a void space having a peripheral boundary, the acoustical insulator comprising:
a first sheet and a second sheet joined to one another in an opposed, facing relationship, the first sheet and the second sheet each comprising a fibrous, air permeable material, wherein at least one of the first sheet and the second sheet is contoured so that an air gap is defined between the first sheet and the second sheet, and at least one of the first sheet and the second sheet substantially extends along the peripheral boundary of the void space, wherein
the first sheet and the second sheet are spaced from one another by the air gap by at least a first gap length in a first area and a second gap length in a second area, the first gap length being less than the gap length, and
in the first area, one of the first sheet and the second sheet has a density that is greater than a respective density of the other sheet in the second area, so that the first area comprising the first gap length and the first density, and the second area comprising the first gap length and the first density are each operative for providing the composite air flow resistance through the acoustical insulator so that noise is absorbed at a predetermined peak frequency.
